(19) United States
(12) Patent Application Publication
(10) Pub. No.: US 2017/0009933 A1
(43) Pub. Date: Jan. 12, 2017

(54) Stabilized Gimbal for Moving and Airborne Platforms

(71) Applicant: Itzhak Sapir, Irvine, CA (US)

(72) Inventor: Itzhak Sapir, Irvine, CA (US)

(21) Appl. No.: 15/204,125

(22) Filed: Jul. 7, 2016

Related U.S. Application Data
(60) Provisional application No. 62/190,990, filed on Jul. 10, 2015.

(51) Int. Cl. F16M 11/12; F16M 11/18; F16M 13/02; B64C 39/02; B64D 47/08

(52) U.S. Cl. CPC F16M 11/123; B64C 39/024; B64D 47/08; F16M 13/02; F16M 11/18; F16M 2200/041

(57) ABSTRACT

A gimbal for airborne and moving platforms that uses a gyroscope as a rotational anchor for payload stabilization. Unlike current stabilized gimbals that sense rotations and correct by using motors, the proposed gimbal uses a passive approach that maintains the payload orientation instead of forcing it back after it rotated out of the desired orientation.

### CROSS-REFERENCE TO RELATED APPLICATIONS

This application claims the benefit of U.S. Provisional Patent Application No. 62/190,990, filed on Jul. 10, 2015 entitled “Stabilized Gimbal for Moving and Airborne Platforms” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of Gimbal Stabilization. More specifically, the invention relates to stabilization of current gimbals for airborne platforms by using a gyroscopic anchor that maintains its orientation regardless of the platform's movements.

2. Description of the Related Art

Current stabilized gimbals for airborne and moving platforms employ active stabilization methods by using sensors for sensing rotational motion of individual axes and motors for applying correctional rotations to said axes. This type of stabilization presents two drawbacks in response time and in power consumption. The proposed stabilization method of the current invention improves on these two drawbacks.

### BRIEF SUMMARY OF THE INVENTION

Applicant discloses a stabilized gimbal for airborne and moving platforms. Said gimbal consists of primary and secondary stabilized frames and a controlled-motion payload frame nested within said secondary frame. A fast spinning gyroscope is connected to said stabilized frame in a way that maintains the orientation of the secondary frame and of the payload frame regardless of the platform's orientation.

Said gyroscope is spinning continuously with no acceleration after the initial startup resulting low power consumption. The gyroscopic effect does not react to the platform's movements but rather behaves as an anchor resulting zero response delay.

### BRIEF DESCRIPTION OF THE DRAWINGS

FIG. 1 shows a Side View, Level Flight.

FIG. 2 shows a Front View, Level Flight.

FIG. 3 shows a Top View, Level Flight.

FIG. 4 shows a Top Isometric View, Level Flight.

FIG. 5 shows a Side View, Down Pitch.

FIG. 6 shows an Isometric View, Down Pitch and Right Roll.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

Turning now to the figures wherein like references define like elements among the several views, Applicant discloses an approach for gimbal stabilization which uses the gyroscopic effects of a fast-spinning mass connected to moving frames within the gimbal to prevent the stabilized frames from rotating while the platform around them rotates.

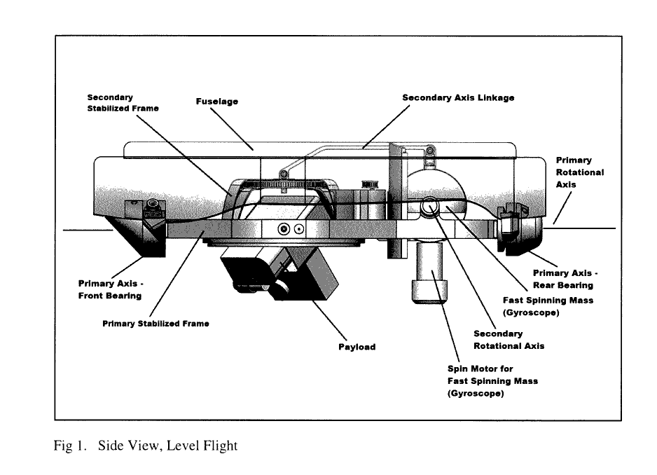

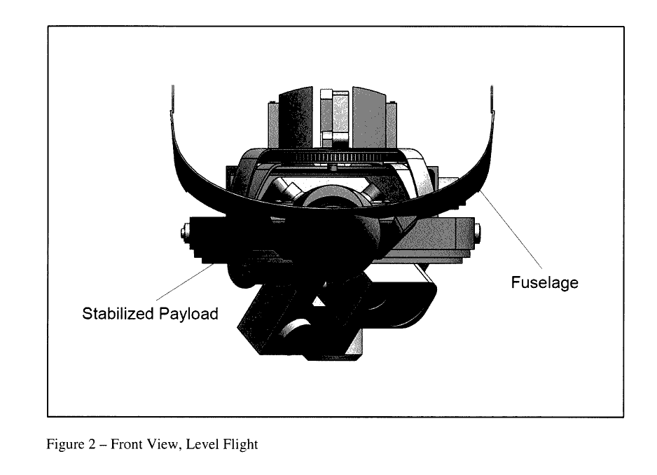

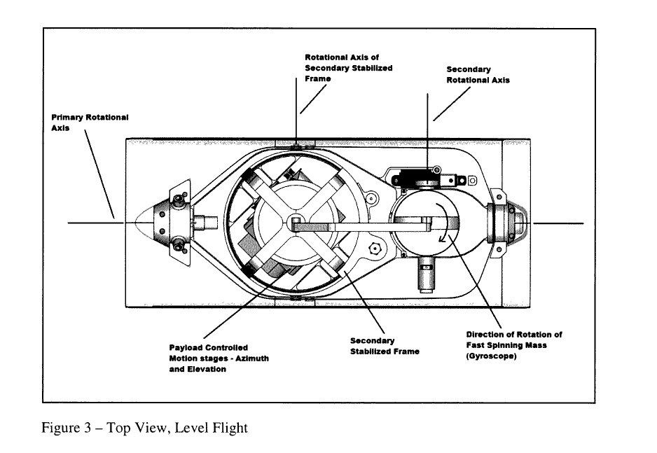

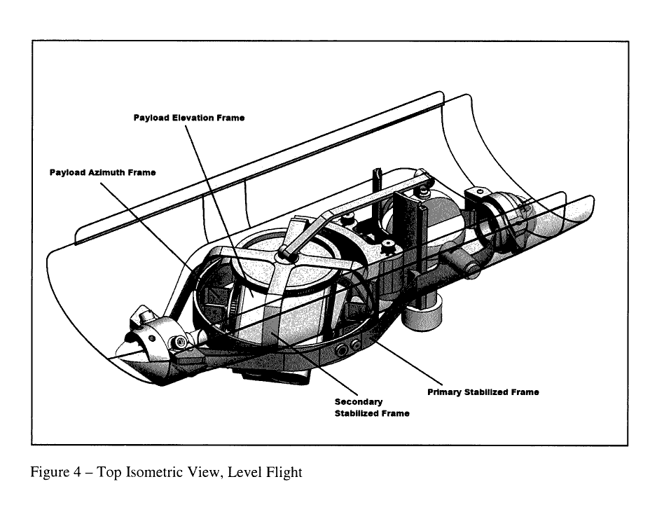

FIGS. 1, 2, 3 and 4 show side, front, top and isometric views of the stabilized gimbal assembly in level flight. The stabilizing “anchor” of the system is a fast spinning mass (gyroscope) that its stationary frame is connected to a primary stabilized frame in a way that anchors the rotation around the primary rotational axis. This connection is done along a pivot axis (through two bearings along an axis perpendicular to the primary rotational axis) that provides a secondary rotational axis. This secondary “anchoring” is transferred to a secondary frame via a linkage. The secondary frame is the stabilized frame of the system to which the payload is connected via two controlled-motion frames, azimuth and elevation.

The geometry (radial length) of the connecting elements between the linkage and the gyroscope on one side and the linkage and secondary frame on the other side is identical in order to copy the motion identically.

Some of the elements shown in these figures such as gears, pulleys, stiffeners, motors and encoders are part of the system's detailed design and are not crucial to the conceptual operation of the system, therefore, they are not captioned and explained.

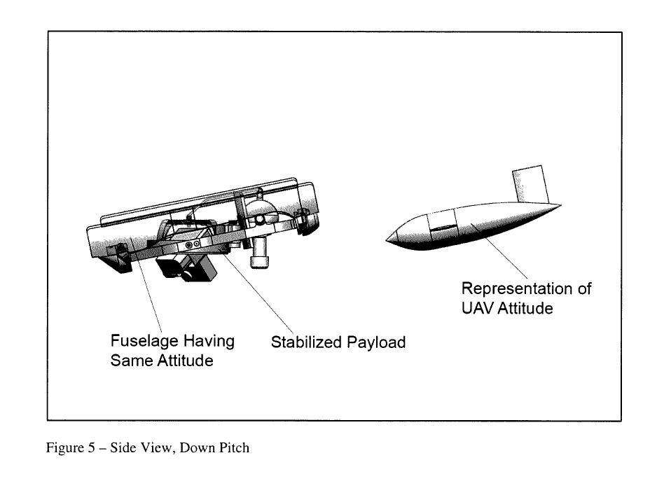

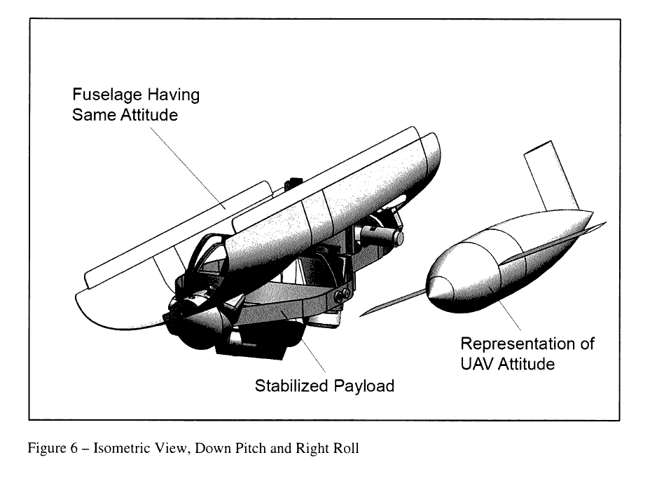

FIGS. 5 and 6 show the system's orientation at a time that the platform is not level but has arbitrary roll and pitch attitude. As can be seen in these figures, the gyroscope keeps pointing to the original direction (spin motor pointing down) and the stabilized frame's orientation remains parallel to that of the gyroscope.

The configuration shown in the above figures was derived from volume constrains of a particular system. A different preferred embodiment of the invention will have the gyroscope rigidly connected to the secondary frame instead of having two parallel secondary axes and a linkage. The stabilization effect of this preferred embodiment would be similar to the one described above.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

We claim:

1. A gimbal for airborne platforms comprised of a fast-spinning mass (gyroscope) and two, primary and secondary frames having orthogonal exes of rotation nested within one another. Said gyroscope is connected to said frames in a way that provides orientational stability to said secondary frame by using the gyroscopic forces developed in said gyroscope.

2. A gimbal for airborne platforms comprised of a fast-spinning mass (gyroscope), a primary frame rotatable around a primary axis, a secondary frame rotatable around a secondary axis perpendicular to said primary axis and nested within said primary frame, and a linkage. Said gyroscope spins at a fast rotational speed to provide gyroscopic force thus orientational anchoring to said primary frame around said primary axis. Said gyroscope is connected to said primary frame along said secondary rotational axis. Said secondary frame is connected to said primary frame with a pivot axis parallel to said secondary rotational axis. Said linkage connects said gyroscope to said secondary frame in a way that transfers the motion of said gyroscope to said secondary frame around said secondary rotational axis. Said Gimbal with all said components provides orientational stability to said secondary frame regardless of said platform's orientation.

3. A gimbal in claim 2 also comprised of motors on all rotating axes

4. A gimbal in claim 2 also comprised of encoders on all rotating axes

5. A gimbal in claim 2 where said linkage is a rigid member

6. A gimbal in claim 2 where said linkage is a pulley/belt assembly

7. A gimbal for moving platforms comprised of a fast-spinning mass (gyroscope), a primary frame rotatable around a primary axis, a secondary frame rotatable around a secondary axis perpendicular to said primary axis and nested within said primary frame, and a linkage. Said gyroscope spins at a fast rotational speed to provide gyroscopic force thus orientational anchoring to said primary frame around said primary axis. Said gyroscope is connected to said primary frame along said secondary rotational axis. Said secondary frame is connected to said primary frame with a pivot axis parallel to said secondary rotational axis. Said linkage connects said gyroscope to said secondary frame in a way that transfers the motion of said gyroscope to said secondary frame around said secondary rotational axis. Said Gimbal with all said components provides orientational stability to said secondary frame regardless of said platform's orientation. Said gimbal with all said components operational provides orientational stability to said secondary frame regardless of said platform's orientation.

8. A gimbal in claim 7 also comprised of motors on all rotating axes

9. A gimbal in claim 7 also comprised of encoders on all rotating axes

10. A gimbal in claim 7 where said linkage is a rigid member

11. A gimbal in claim 7 where said linkage is a pulley/belt assembly
